(19) United States
(12) Patent Application Publication
(10) Pub. No.: US 2026/0049017 A1
(43) Pub. Date: Feb. 19, 2026

(54) FIXED BED DESALINATION REACTOR

(71) Applicant: Badwater Alchemy Technologies Inc., Seattle, WA (US)

(72) Inventors: Ozgur Emek Yildirim, Bellevue, WA (US); William J. Walker, Seattle, WA (US); Andrew F. Mason, Seattle, WA (US)

(73) Assignee: Badwater Alchemy Technologies Inc., Seattle, WA (US)

(21) Appl. No.: 19/301,782

(22) Filed: Aug. 15, 2025

Related U.S. Application Data
(60) Provisional application No. 63/684,148, filed on Aug. 16, 2024.

(51) Int. Cl. C02F 9/00; B01J 20/02; B01J 20/28; B01J 20/30; B01J 20/32; C02F 1/00; C02F 1/28; C02F 1/74; C02F 103/08

(52) U.S. Cl. CPC C02F 9/00; B01J 20/0229; B01J 20/28045; B01J 20/28083; B01J 20/28085; B01J 20/305; B01J 20/3202; C02F 1/001; C02F 1/281; C02F 1/74; C02F 2103/08; C02F 2201/007; C02F 2201/008

(57) ABSTRACT

An example method includes receiving saline water at a desalination tank, the desalination tank including a porous substrate impregnated with metal particles in a fixed position within the desalination tank, contacting the saline water with the porous substrate to remove impurities from the water, thereby forming treated water, and outputting the treated water.

### CROSS-REFERENCE TO RELATED APPLICATION

This application claims priority to U.S. Provisional App. No. 63/684,148, which was filed on Aug. 16, 2024, is titled “FIXED BED DESALINATION REACTOR,” and is incorporated by reference herein in its entirety.

### BACKGROUND

Freshwater is essential for agricultural, industrial, and domestic uses. According to the United Nations (UN), about half of the world's population experiences severe freshwater scarcity every year (UN World Water Development Report, 19 Mar. 2024). An increase in freshwater demand from trends of population growth and socio-economic development may further exacerbate this problem.

Freshwater can be produced by desalinating brackish water and seawater, which is more readily available than existing freshwater. Desalination is increasingly important for producing drinking water and irrigation water in arid climates. For example, a majority of drinking water in Israel is now produced using desalination. In the United States (US), desalination plants in some areas already produce a significant amount of municipal drinking water. Many existing desalination plants utilize reverse osmosis (RO) for water desalination. However, RO and many other previous desalination technologies (e.g., distillation, ion exchange, electrodialysis, etc.) have several drawbacks that prevent widespread use. For instance, many of these techniques utilize significant energy expenditures during operation. Other costs, as well as reliability concerns, associated with these techniques limit their widespread use.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example desalination system in accordance with various implementations of the present disclosure.

FIG. 2 illustrates an example environment for controlling a desalination system.

FIGS. 3A and 3B illustrate examples of metal particles configured to adsorb sodium (Na) and chlorine (Cl) atoms.

FIG. 4 illustrates at least one example device configured to enable and/or perform various functionality discussed herein.

FIG. 5 illustrates an example process for capturing solutes from an aqueous solution.

### DETAILED DESCRIPTION

Various systems, devices, and methods described herein relate to improved techniques for removing solutes from water. In particular cases, water can be efficiently and quickly desalinated using various techniques described herein.

In various implementations, a desalination system includes one or more desalination tanks that receive saline water. In various cases, each desalination tank includes a desalination substrate, which includes at least one porous substrate impregnated with metal particles (e.g., metal nanoparticles). The metal particles, for example, include at least one of copper, aluminum, magnesium, manganese, zinc, or iron. In some cases, the metal particles include a metal alloy that includes multiple metals. The metal particles are configured to remove, from the saline water, one or more contaminants when the metal(s) in the particles oxidize. Examples of the contaminants include sodium, chloride, calcium, magnesium, potassium, and sulfate. In some cases, the porous substrate is configured to remain fixed within the desalination tank, such that the metal particles are not in a slurry mixed with the treated water, and therefore do not need to be removed from the treated water.

In implementations, the process of desalinating water may include regenerating the metal particles, such as by backwashing the porous substrate and/or redissolving the metal particles. In implementations, treated water may be passed through one or more water purification stages, such as desalination, oxidation, filtration, activated carbon, ultraviolet light, coagulation, or flocculation. For example, filtration may include a membrane filter, a particulate filter, a ceramic filter, a glass fiber filter, a hollow fiber filter, or any combination thereof. In implementations, one or more additives may be added to the treated water, such as at least one of electrolytes, chlorine, or fluorine. In implementations, the treated water may be output to a user, to an agricultural application, to a municipality, or to the environment. For example, some implementations described herein are suitable for consumer uses, in which a porous substrate is included in a housing configured to be coupled to a faucet head or water bottle.

Optionally, an oxidizing agent is introduced into the desalination tank(s). In particular cases, the oxidizing agent incudes a gas that produces bubbles in a fluid mixture of the saline and desalination substrate in the desalination tank(s). Solutes in the saline water are captured and/or removed due to the presence of the desalination substrate. For instance, oxidation of the metal particles results in capture of solutes such as sodium and chloride ions in the saline. The oxidizing agent, in various cases, can greatly increase the speed and efficiency of solute capture by the metal particles. For instance, using techniques described herein, at least 80% of sodium and chloride can be removed from saline water in less than one day (e.g., eight to 10 hours).

In various cases described herein, the desalination tank(s) are part of a continuous, feed-through desalination system. For example, the desalination tank(s) are part of a fluid circuit that receives saline water at an inlet and produces desalinated water at an outlet. Various structures within the desalination system can enhance the speed and efficiency of the continuous system. These structures optionally include baffles, one or more settling tanks, physical filters, valves, pumps, or any combination thereof. In some cases, a standalone desalination system described herein can be transported to a remote site (e.g., in a boxcar or other modular housing) and used to treat water with minimal energy expenditure.

Various implementations of the present disclosure will now be described with reference to the accompanying figures.

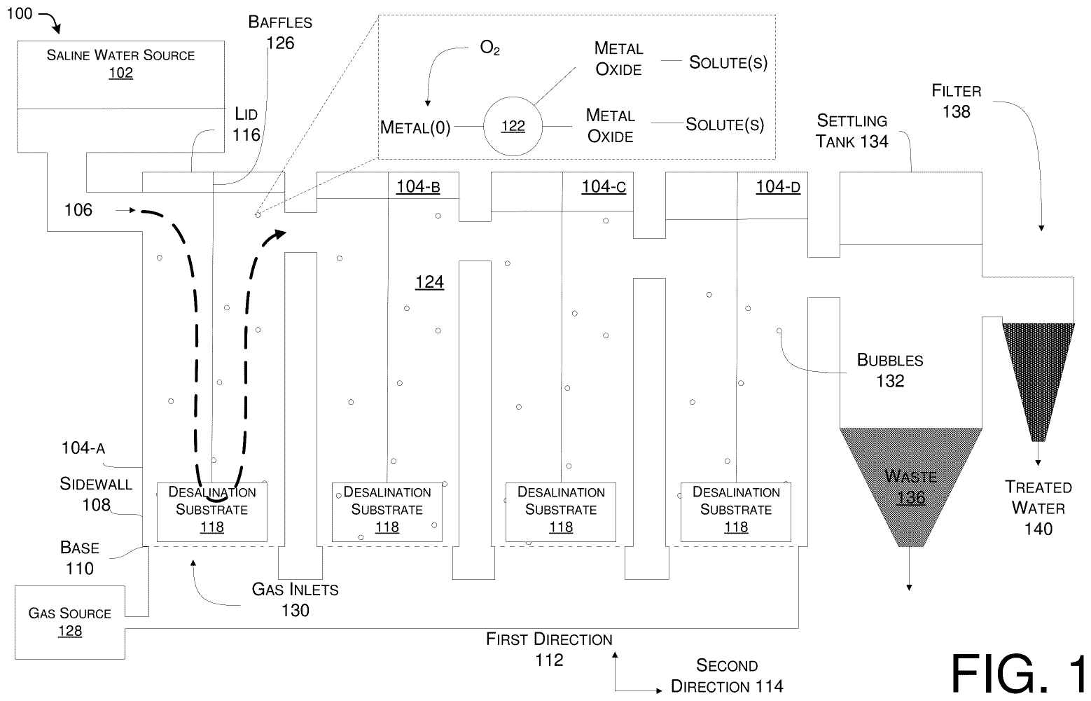

FIG. 1 illustrates an example desalination system 100 in accordance with various implementations of the present disclosure. The desalination system 100 receives saline water from a saline water source 102. That is, the saline water may be influent water into the desalination system 100. As used herein, the terms “saline,” saline water,” and their equivalents, may refer to an aqueous solution including dissolved salts, metals, solids, other contaminants, or any combination thereof at greater than a threshold concentration (e.g., greater than 3% salinity). In some cases, other types of aqueous solutions including other dissolved solutes can be substituted for the saline water in the saline water source 102. In various cases, saline water is unfit for human and/or animal consumption. In some cases, saline water is unfit for a water supply for plants, such as in an agricultural context. In various examples, saline may include seawater, industrial waste, mining waste, agricultural waste, produced water (e.g., a byproduct of ground oil and/or gas extraction), flowback (e.g., water injected and returned during a hydraulic fracturing process), or any combination thereof. In some examples, saline water includes brine. As used herein, the term “brine,” and its equivalents, may refer to an aqueous solution having greater than 5% salinity. The saline water source 102, for instance, includes a tank. The term “tank” and its equivalents refer to a vessel, container, or the like configured to hold a liquid, a solid, a slurry, a mixture, a gas, or any combination thereof. In implementation, a tank can be fluidically connected to other tanks, pipes, pumps, valves, or other structures. In some cases, the saline water source 102 includes one or more pipes, pumps, tanks, valves, or other structures by which saline water can be transported to the desalination system 100. In some cases, the saline water has a nonzero total dissolved solid (TDS), such as a TDS in a range of about 10,000 parts-per-million (ppm) to about 100,000 ppm.

The saline water enters a first desalination tank 104-a through a water inlet 106, which is fluidly coupled to the saline water source 102. In the example illustrated in FIG. 1, the water inlet 106 extends through a sidewall 108 of the first desalination tank 104-a. The sidewall 108 extends from a base 110 of the first desalination tank 104-a. The sidewall 108 may be parallel to a first direction 112 and the base 110 may be parallel to a second direction 114, wherein the first direction crosses the second direction. During operation of the desalination system 100, the first direction 112 may be opposite of a direction of gravity. In some cases, the sidewall 108 is perpendicular to the base 110. In some examples, the base 110 has a polygonal (e.g., rectangular) and/or circular shape. A lid 116 may be removably coupled to the sidewall 108. The sidewall 108, base 110, and lid 116 include one or more materials configured to contain water, such as saline water. In some examples, the sidewall 108 and base 110 include a metal (e.g., stainless steel), a polymer (e.g., polyethylene), glass, or any combination thereof.

In various implementations, the first desalination tank 104-a can include a desalination substrate 118 disposed within the first desalination tank 104-a and configured to capture one or more solutes in the saline water output from the saline water source 102. The desalination substrate 118 can be fixed and stationary within the first desalination tank 104-a during operation of the desalination system 100. In some cases, the desalination substrate 118 is removably coupled to the first desalination tank 104-a, for example, so the desalination substrate 118 may be removed or replaced.

The desalination substrate 118, in various cases, includes a porous substrate impregnated with metal particles 122. In implementations, the porous substrate can include at least one of anthrosite, a zeolite, activated carbon, a carbon matrix, alumina, an inorganic oxide, silica, or sand. The porous substrate can include pores and/or channels, wherein pores and/or channels in the porous substrate have widths in a range of about 10 nanometers (nm) to about 200 millimeters (mm), for example 10 nm to 20 mm. According to some examples, one or more pores and/or channels of the porous substrate extend through the porous substrate, such that a fluid can flow from one side of the porous substrate to another side of the porous substrate. In various cases, the porous substrate may have a relatively high surface area exposing the metal particles 122 to the saline water. For instance, the desalination substrate 118 and/or the porous substrate may have a surface-to-volume ratio of at least 12:1.

The exposed metal particles 122 on the surface of the porous substrate are configured to remove one or more contaminants from the saline water. In implementations, the porous substrate includes at least one of a fused metal powder, a metallic foam, a scaffold, a truss, one or more rods, a continuous or semi-continuous surface coating disposed on a substrate, one or more patterns imprinted on a substrate, one or more pellets, or a slurry including particles fixed within the desalination tank by at least one of a membrane, a screen, or a mesh. In implementations, a fused metal powder can include zinc oxide particles (powder) fused with the metal particles 122. In implementations, the metallic foam can include the metal particles 122. In implementations, the continuous or semi-continuous surface coating can include a porous material, such as anthrosite, a zeolite, activated carbon, a carbon matrix, alumina, an inorganic oxide, silica, or sand. The continuous or semi-continuous surface coating can be applied to and/or disposed onto a surface, such as a non-porous surface or porous surface, and the continuous or semi-continuous surface coating can be impregnated with metal particles 122. The continuous or semi-continuous surface coating can include pores and/or channels, wherein pores and/or channels in the porous substrate have widths in a range of about 10 nanometers (nm) to about 200 millimeters (mm), for example 10 nm to 20 mm. For example, a continuous or semi-continuous surface coating including a porous material can be disposed onto a non-porous substrate, thereby allowing the non-porous substrate to become impregnated with metal particles 122.

For example, the metal particles 122 include copper, aluminum, magnesium, manganese, zinc, iron (such as zero valent iron (ZVI)), or any combination thereof. In some cases, the metal particles 122 include an alloy of multiple metals. In some examples, the metal particles 122 include at least one oxidized metal. For instance, the metal particles 122 include one or more metal oxyhydroxides (e.g., iron oxyhydroxide). In some cases, the metal particles 122 may include a network structure of atoms (e.g., metal atoms and/or any combination of metal atoms, hydrogen atoms, and oxygen atoms) that are bonded to each other. The network structure may be cubic, tetragonal, or the like. The desalination media, for instance, includes a mixture of water and the metal particles 122. According to various cases, a concentration of the particles in the desalination media is in a range of 0.1 grams per liter (g/L) to 100 g/L, such as in a range of 1 g/L to 50 g/L or a range of 10 g/L to 25 g/L.

According to various cases, the metal particles 122 include one or more metals in a zero valency state, such as zero-valent iron (ZVI). As used herein, the term “Zero Valent Iron (ZVI),” “zerovalent iron,” “nonvalent iron,” “Fe(0),” and their equivalents, can refer to one or more iron atoms with a valency of zero. In some cases, iron can change between a zerovalent state and a multivalent state, such as the trivalent Fe3+ form.

When metal atoms on the surface of the metal particles 122 become oxidized, the atoms may be converted into multivalent metal atoms. As used herein, the term “oxidation,” and its equivalents, can refer to a chemical reaction in which at least one atom loses electrons. As used herein, the term “reduction,” and its equivalents, can refer to a chemical reaction in which at least one atom gains electrons. In a “reduction-oxidation” or “redox” reaction, electrons are transferred from one chemical species (e.g., a species undergoing oxidation) to another chemical species (e.g., a species undergoing reduction). For example, ZVI can be oxidized when it reacts with an oxidizing species (e.g., oxygen gas, air, ozone, etc.) to form other valency states, such as Fe(II) and/or Fe(III). In particular cases, the metal particles 122 include an oxyhydroxide, such as Fe(III) oxyhydroxide, (FeO(OH)).

When one or more metals in the metal particles 122 are converted into a multivalent state, such as through the process of oxidation, the resultant material may include charged atoms. For instance, oxygen atoms in the oxyhydroxide(s) of the metal particles 122 may be negatively charged, whereas hydrogen atoms in the oxyhydroxide(s) of the metal particles 122 may be positively charged. In various cases, the electrical charges of various atoms within the metal particles 122 is dependent on the pH of the bulk solution. The positive and negative charges of various atoms within the metal particles 122 causes the metal particles 122 to electrostatically attract charged solutes in the vicinity of the metal particles 122. For instance, negatively charged solutes (e.g., chloride ions) in the saline water may be electrostatically attracted to positively charged atoms (e.g., hydrogen atoms) in the metal particles 122. Further, positively charged solutes (e.g., sodium ions) in the saline water may be electrostatically attracted to negatively charged atoms (e.g., oxygen atoms) in the metal particles 122. Further, in some instances, the charged solutes may become covalently bonded to each other and/or to metals on the surface of the particles. Accordingly, the charged solutes in the saline water may be adsorbed onto the surfaces of the metal particles 122. In various cases, the metal particles 122 are configured to remove dissolved salts, such as dissolved sodium chloride, from the saline water. Accordingly, the metal particles 122 may be utilized to at least partially desalinate the saline water.

In some cases, the desalination substrate includes additional materials. In various cases, the metal particles 122 are generated using a mixture of metal salts and a reducing agent. Examples of the metal salts include, for instance, metal chlorides (e.g., iron chloride), metal nitrates (e.g., iron nitrate), metal sulfates (e.g., iron sulfate), or other types of metal salts. Examples of the reducing agent, in various cases, include uric acid, urea, tartaric acid, maleic acid, or tannic acid. According to various examples, the mixture may be acidic. For instance, the mixture may have a pH in a range of 2 to 7, such as a pH in a range of 2.5 to 5.0. In some implementations, the mixture may be configured to be stored for an extended period of time (e.g., days, weeks, months, or years), and may include one or more materials configured to prevent or minimize bacterial growth within the mixture during storage. In some cases, the mixture is stored in a kit (e.g., including a polymer package that prevents contamination during storage). The metal particles 122 in the mixture can be adsorbed, adhered, bound, fused, or otherwise attached to the underlying substrate of the desalination substrate 118.

In some cases, the metal particles 122 within the desalination substrate 118 can include metal nanoparticles. As used herein, the term “nanoparticle,” and its equivalents, can refer to a solid particle that is shorter than 100 nanometers (nm) in at least one dimension. In some cases, a nanoparticle can have a diameter of less than 100 nm. A metal nanoparticle, for example, can be a nanoparticle including (and possibly consisting of) metal atoms. In some cases, a metal nanoparticle may include a network structure of metal atoms that are covalently bonded to each other. The network structure may be cubic. In some cases, the metal nanoparticles may be mixed with aluminum, magnesium and/or copper nanoparticles.

As used herein, a “size,” “length,” “diameter,” or their equivalents of a particle may refer to a Z-average diameter (e.g., as determined using Dynamic Light Scattering (DLS)). In some cases, a “size,” “length,” “diameter,” or their equivalents, of multiple particles may refer to a Z-average diameter in which the particles have a weighted differential size distribution within ±10% of the Z-average diameter. In various implementations described herein, the particles 122 may, for instance, may be assumed to have spherical shapes, such that a Z-average diameter of the particles 122 (e.g., generated using DLS) in suspension may be between 1 and 100 nm. In some cases, the nanoparticles among the particles 122 may have a Z-average diameter that is between 40 to 60 nm, such as about 50 nm. In some implementations, at least 90% of a (volume or intensity) weighted differential size distribution of the particles 122 in solution (e.g., generated using DLS) may be between 20 and 80 nm, such as about 50 nm. In some cases, the length of the particle 122 can be defined by microscope measurements (e.g., via at least one optical microscope, an electron microscope, a scanning probe microscope, or the like), settling velocities (e.g., by applying Stokes'law to a measured velocity of the particle), and/or sedimentation methods.

A water travels through a fluid circuit including an interior space of the first desalination tank 104-a. In various cases, the fluid circuit further includes the interior of a second desalination tank 104-b, a third desalination tank 104-c, and a fourth desalination tank 104-d. The first to fourth desalination tanks 104-a to 104-d are connected to one another in series, such that the water 124 travels through the first desalination tank 104-a, then the second desalination tank 104-b, then the third desalination tank 104-c, then the fourth desalination tank 104-d. In implementations, a desalination substrate 118 can be disposed within and/or removably coupled to any one or more of the first to fourth desalination tanks 104-a to 104-d. For instance, the desalination substrate 118 may spontaneously sink to the base 110 of each desalination tank 104-a to 104-d. In some cases, the desalination substrate 118 is strapped to an interior surface of each desalination tank 104-a to 104-d via one or more fasteners. Examples of fasteners include buckles, magnetic couplings, screws, or the like.

The first to fourth desalination tanks 104-a to 104-d each include baffles 126. The baffles 126 extend parallel to the first direction 112 within the interior of each of the first to fourth desalination tanks 104-a to 104-d. In various implementations, the baffles 126 extend from the lid 116 of the corresponding desalination tank among the first to fourth desalination tanks 104-a to 104-d and are spaced apart from the base 110 of the corresponding desalination tank. In some cases, the baffles 126 may be coupled to a floatation device that floats on the surface of the water 124 and extends in a direction opposite to the first direction 112 into the water 124. In some cases, at least some of the baffles 126 are configured to extend from the base 110 of the corresponding desalination tank among the first to fourth desalination tanks 104-a to 104-d and are spaced apart from the lid 116 and/or an upper surface of the water 124. Due to the spacings between the baffles 126 and the walls of the desalination tanks 104-a to 104-d, the fluid circuit within the interior of the desalination tanks 104-a to 104-d may have a winding path through the desalination system 100.

According to various implementations, the metal particles 122 within the water 124 are configured to capture one or more solutes within the water 124. In various implementations, a metal (e.g., Fe(0)) in the metal particles 122 oxidizes within the water 124. As a result of the oxidation reaction, the solute(s) are bound to the metal particles 122. In various implementations, the solute(s) include one or more metals, such as at least one of copper, zinc, manganese, aluminum, selenium, or one or more radionuclides. In some cases, the solute(s) include dissolved ions, such as at least one of sodium, chloride, phosphate, sulfate, arsenic, nitrate, nitrite, or hypochlorite. In various implementations of the present disclosure, the metal particles 122 within the water 124 can be used to desalinate the water 124.

In particular cases, the solute(s) in their aqueous form are charged. For example, at least some of the solute(s) may have a positive charge. Examples of solutes having a positive charge include, for instance, sodium ions (Na+), copper ions (Cu2+), zinc ions (Zn2+), manganese ions (Mn2+), aluminum ions (Al3+), or arsenic ions (As5+). The metal oxide in the metal particles 122 has a negative charge. Accordingly, the positively charged solute(s) may electrostatically bind to the oxidized metal particles 122. Further, at least some of the solute(s) may have a negative charge. Examples of solutes having a negative charge include, for instance, chloride ions (Cl−), selenium ions (Sn2−), phosphate ions (PO₄3−), sulfate ions (SO₄2−), nitrate ions (NO₃−), nitrite ions (NO−), or hypochlorite ions (ClO−). The negatively charged solute(s) may electrostatically bind to the positively charged solute(s) bound to the oxidized metal particles 122. Various other mechanisms for capturing solute(s) are also possible.

Experimentally, it was observed that a batch system, in which saline water was introduced to a metal nano media (i.e., a media that includes metal nanoparticles) and held in a static vessel, could result in a significant reduction of solute(s) in the water. However, such batch systems were limited by how much of the solute(s) could be captured. In addition, batch systems were observed to take weeks in order to achieve significant capture of the solute(s).

In implementations, the metal particles 122 can be regenerated. For example, regenerating the metal particles can include backwashing the desalination substrate 118 and/or redissolving the metal particles 122. For example, a desalination substrate 118 can be backwashed while disposed within a desalination tank, for example any one of the first to fourth desalination tanks 104-a to 104-d. In implementations, the desalination substrate 118 can be removed from one or more of the desalination tanks 104-a to 104-d, regenerated, and then reinstalled within the one or more desalination tanks 104-a to 104-d. In implementations, redissolving the metal particles can include flushing the porous substrate with clean water adding and/or introducing a reducing agent to the porous substrate. In implementations, the reducing agent can include nitrogen gas, an oxygen-consuming microorganism, a nitride, a nitrate, calcium, barium, sodium borohydride, an alcohol, a phenol, uric acid, urea, tartaric acid, maleic acid, or tannic acid.

In various cases, a gas is introduced from a gas source 128 and through gas inlets 130 within the base 110 of each desalination tank among the desalination tanks 104-a to 104-d. The gas, for instance, propagates through desalination substrate 118 and through the water 124 in the form of bubbles 132. For example, the bubbles 132 can travel substantially in a first direction 112 through the desalination substrate 118 by passing through pores, channels, or other fluidically connected spaces within the desalination substrate 118, or by passing in the first direction 112 through a fused metal powder, metallic foam, or slurry of the desalination substrate 118. The bubbles 132 can leave the desalination substrate and travel through the water 124 in the first direction 112.

The gas in the bubbles 132, in various cases, includes an oxidizing gas that enhances the oxidation reaction of the metal in the nanoparticles (e.g., the reaction from ZVI to iron(III) oxide). The oxidizing gas, for example, can include oxygen, such as oxygen from air. In some cases, the gas includes additional gases to prevent explosions, fires, and other risks when the desalination system 100 is operating. For instance, the gas may include nitrogen gas, carbon dioxide, carbon monoxide, or other inert gases. In some examples, the gas includes air.

In at least a portion of the fluid circuit throughout the desalination system 100, the bubbles 132 move countercurrent to the water within the water 124. For example, the metal particles 122 may travel in a direction that crosses and/or is opposite to the first direction 112 in at least a portion of the fluid circuit, while the bubbles 132 rise in the water 124 in the first direction 112. The baffles 126, in some cases, may cause the metal particles 122 and the water 124 to flow in a direction that opposes the first direction 112. In some examples, pumps and/or pipes (not illustrated) are included within the interior of the first to fourth desalination tanks 104-a to 104-d to cause the water to move countercurrent to the bubbles 132.

To minimize space within the fluid circuit in which the bubbles 132 are not present, in various cases, the gas inlets 130 are distributed throughout the major area of the base 110. In some cases, the gas inlets 130 are distributed at a substantially even density throughout the base 110. For example, a number of gas inlets 130 per square area at a center of the base 110 may be substantially equal to a number of gas inlets 130 per square area at an edge of the base 110. The distribution of gas inlets 130 may prevent spaces within the desalination tanks 104-a to 104-d in which the bubbles 132 do not traverse, thereby increasing the volume within the fluid circuit in which the oxidizing reaction of the metal particles 122 takes place.

The size of the gas inlets 130 and/or the bubbles 132 may impact the efficiency of the reaction within the desalination system 100. In some cases, an individual gas inlet among the gas inlets 130 (e.g., each gas inlet 130) has a width in a range of 0.001 meter (m) to 0.1 m, a range of 0.001 m to 0.01 m, or the like. In some cases, the number of gas inlets 130 within a single base 110 is in a range of 1 to 1,000,000, 10 to 1,000, or 10 to 100.

Experimentally, it was observed that the rate of the gas entering the desalination tanks 104-a to 104-d can impact the efficiency of the desalination reaction. If the gas is introduced into the desalination tanks 104-a to 104-d at too low of a rate, the reaction may not be significantly sped up by the gas. However, if the gas is introduced into the desalination tanks 104-a to 104-d at too fast of a rate, then the reaction may occur so quickly that the solute(s) may be inefficiently bound to the metal oxide. Accordingly, in various implementations of the present disclosure, the gas is introduced into the water 124 at a rate in a range defined between a lower threshold and an upper threshold, such as in a range of 0.5 liter per minute(L/min) to 3 L/minute or in a range of 1 L/min to 2 L/min.

In various implementations of the present disclosure, the desalination system 100 is a flow-through system that provides greater desalination efficiency than a batch system. Once the water 124 traverses the fourth desalination tank 104-d, the water 124 flows into a settling tank 134. In some cases, the settling tank 134 lacks baffles 126. In various examples, the settling tank 134 substantially lacks bubbles 132. In some examples, the settling tank 134 is at least partially cone-shaped. When the water 124 is in the settling tank 134, solids in the water 124 spontaneously sink to the bottom of the interior of the settling tank 134 in the form of waste 136. In various cases, the waste 136 is removed from the fluid circuit. In some cases, a valve at the base of the settling tank 134 selectively opens, thereby allowing the waste 136 to drain from the settling tank 134. In some examples, a vacuum line is coupled to the base of the settling tank 134, which pulls the waste 136 out of the settling tank 134. Once removed, the waste 136 may be disposed of.

The remaining water 124 in the settling tank 134 flows into a filter 138. The filter 138, in various cases, further removes waste 136 from the water 124. In various cases, the filter 138 is a physical filter that includes activated carbon. For instance, the filter 138 includes a housing (e.g., a polymer and/or metal housing) that encloses activated carbon particles. In various cases, remaining solids are removed from the mixture by the filter 138. The filter 138, in various cases, releases treated water 140. The treated water 140, for instance, is effluent water discharged from the desalination system 100.

According to various implementations of the present disclosure, the desalination system 100 efficiently removes the solute(s) from the saline water. Experimentally, it has been shown that a similar system can remove at least 80% of dissolved sodium chloride from saline and/or brine in less than 10 hours (e.g., in a time range that is between 4 and 8 hours).

Although not specifically illustrated in FIG. 1, additional structures may be added to the desalination system 100. It has been observed that the temperature of the water 124 impacts the speed of the desalination process implemented by the desalination system 100. In some examples, the desalination system 100 includes one or more heaters (not illustrated) that increase a temperature of the water 124 above a lower threshold of 10, 15, 20, 25, or 30 degrees Celsius (C) (and below a boiling temperature). Various initial experiments indicate that the desalination rate increases significantly if the water is heated from 17° C. to 35° C. In some cases, a rate of the desalination (e.g., in terms of sodium and/or chloride removed from the water over time) may increase by 10 to 15% if the water is heated by 10° C. In some examples, one or more heaters are coupled to the water inlet 106 of the first desalination tank 104-a. In some cases, the desalination system 100 operates in an environment in which an ambient temperature is greater than 20, 25, or 30° C., such that the heater(s) may be unnecessary and/or deactivated.

In some implementations, the desalination system 100 includes one or more structures configured to control a pH of the water 124. It has been observed that the speed and efficiency of the desalination reaction between metal particles and saline, for instance, can depend on the pH of the water 124. In some examples, the water surrounding the desalination substrate 118 has a pH below 7. For instance, the desalination substrate may include phenols that make a surrounding solution acidic. According to some examples, the desalination system 100 is configured to add a buffer, such as in the form of a buffer solution, to the water 124. The buffer may increase a pH of the water 124. For instance, the buffer may include bicarbonate. In some cases, the buffer is automatically dispensed through an inlet in one or more of the desalination tanks 104-a to 104-d.

According to various cases, fluids are propelled through the fluid circuit within the desalination system 100 via passive and/or active forces. In some examples, the desalination system 100 leverages hydrostatic pressure to propel the water 124 through the fluid circuit. For example, the saline water source 102 may store the saline at a higher altitude (with respect to gravity) than an outlet of the filter 138. In various cases, the water inlet 106 of the first desalination tank 104-a has a greater altitude than an outlet of the first desalination tank 104-a, such that the water 124 flows spontaneously through the first desalination tank 104-a. The inlets and outlets of the second to third desalination tanks 104-b to 104-d, for instance, may have similar relative altitudes. In some cases, the movement of fluids throughout the desalination system 100 are controlled through the fluid circuit via one or more pumps (not illustrated) and/or one or more valves (not illustrated).

In some examples, various components of the desalination system 100 are controlled by one or more processors (e.g., a controller, computing device, or the like). According to some examples, the processor(s) activate one or more of the components based on a predetermined schedule. For example, the processor(s) may cause a valve in the base of the settling tank 134 to open for a predetermined amount of time (e.g., ten minutes) at a predetermined frequency (e.g., every two hours).

In some cases, the processor(s) control the components of the desalination system 100 in response to conditions within the desalination system 100 and/or the saline water source 102. In some cases, one or more sensors (not illustrated) are disposed within the fluid circuit, communicatively coupled with the processor(s), and configured to detect at least one parameter of the desalination system 100. Examples of sensors include temperature sensors, salinity sensors, pH sensors, pressure sensors, light sensors, and the like. Examples of parameters detected by the sensors include, for instance, temperature, salinity, pH, pressure, light absorbance, light transmittance, and the like. The processor(s), for instance, may selectively activate components of the desalination system 100 based on one or more parameters detected by the sensor(s). According to various cases, the processor(s) may activate or deactivate an example component in response to detecting that a parameter is above a first threshold or below a second threshold.

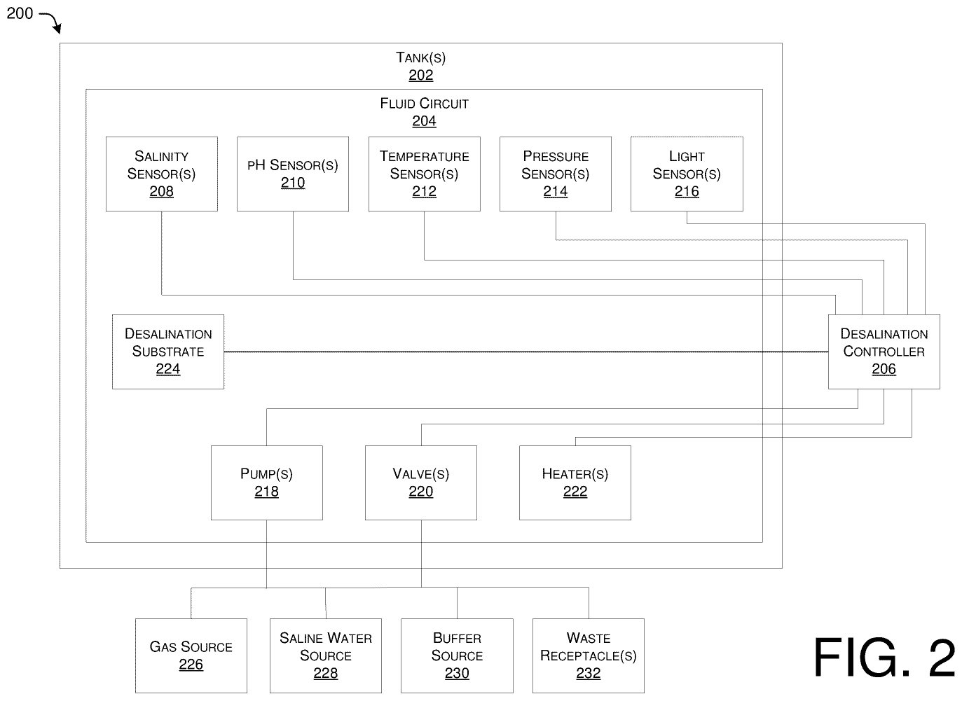

FIG. 2 illustrates an example environment 200 for controlling a desalination system, such as the desalination system 100 described above with reference to FIG. 1. The environment 200 includes one or more tanks 202 that accommodate a fluid circuit 204. For instance, the tank(s) 202 include the first desalination tank 104-a, the second desalination tank 104-b, the third desalination tank 104-c, the fourth desalination tank 104-d, the settling tank 134, the filter 138, or any combination thereof. The fluid circuit 204, in various cases, includes a hollow space that is disposed within the tank(s) 202. In some cases, the fluid circuit 204 includes one or more pipes, tubes, or other structures that connect multiple tanks among the tank(s) 202 together. A fluid, such as water (with or without dissolved solutes), a desalination substrate, a gas (e.g., air, oxygen, etc.), or any combination thereof, can be disposed in the fluid circuit 204. In some cases, the fluid flows through the fluid circuit 204. Although not specifically illustrated, in some cases, the fluid circuit 204 includes one or more inlets and/or one or more outlets.

In various implementations of the present disclosure, a desalination controller 206 is configured to analyze and/or cause modifications to conditions within the fluid circuit 204. In various cases, the desalination controller 206 is configured to optimize the conditions in the fluid circuit 204 to enhance efficient removal of one or more solutes from water disposed in the fluid circuit 204. The desalination controller 206 can be embodied in software and/or hardware. For example, the desalination controller 206 includes at least one computing device, such as a server computer, a laptop, a tablet computer, a smart phone, or other type of computer. In various cases, the desalination controller 206 includes one or more processors configured to execute instructions. The instructions, for instance, are stored in memory and/or non-transitory computer-readable media. By executing the instructions, the desalination controller 206 performs various functions described herein.

In some cases, the desalination controller 206 is located on the premises of the desalination system. For instance, the desalination controller 206 could be packaged with the tank(s) 202 of the desalination system. In some cases, the desalination controller 206 is located remotely from the premises of the desalination system. For instance, the desalination controller 206, in some cases, is implemented in at least one server computer located at least one kilometer (km) away from the tank(s) 202.

Various sensors may be communicatively coupled to the desalination controller 206. As used herein, endpoints are “communicatively coupled,” if they are connected to one another via at least one wired (e.g., electrical, optical, etc.) interface and/or at least one wireless interface (e.g., BLUETOOTH™, cellular, near-field communication (NFC), etc.) over which communication signals can be transmitted between the endpoints. These sensors, in various cases, are configured to detect one or more parameters of the fluid circuit 204. These parameters include at least one of salinity, pH, temperature, pressure, light transmittance, or light reflectance, for example.

At least one salinity sensor 208, for instance, is disposed within the fluid circuit 204. The salinity sensor(s) 208 is configured to detect a salinity level of water in one or more locations within the fluid circuit 204. Examples of the salinity sensor(s) 208 include, for instance, an electrical sensor configured to detect an electrical conductivity of the fluid in the fluid circuit 204. In various cases, the salinity sensor(s) 208 includes an anode and a cathode that are suspended in the fluid, as well as a power source that applies a voltage across the anode and the cathode. In some examples, the salinity sensor(s) 208 detects the electrical conductivity of the fluid by detecting an electrical current between the anode and the cathode. Alternatively, the salinity sensor(s) 208 includes a current source that outputs a current across the anode and the cathode, and then a voltage detector that detects the voltage between the anode and the cathode in order to detect the electrical conductivity of the fluid. In various implementations, the electrical conductivity is proportional to an amount of dissolved solute(s) in the fluid.

At least one pH sensor 210 is disposed in the fluid circuit 204, for example. The pH sensor(s) 210 is configured to detect a pH of the fluid at one or more positions in the fluid circuit 204. In some cases, the pH sensor(s) 210 include a pH electrode bulb including a membrane (e.g., including glass) that is permeable to H+ ions in the fluid. The pH sensor(s) 210 may further include a reference cell that contains a pH neutral electrolyte solution. An electrical sensor is connected to the pH electrode bulb and the reference cell and is configured to detect a voltage between the pH electrode bulb and the reference cell. If H+ ions in the fluid enter the pH electrode bulb, then a voltage is detected by the electrical sensor. The magnitude of the voltage, for instance, is dependent on an amount of H+ ions in the fluid, and is therefore indicative of the acidity of the fluid.

At least one temperature sensor 212 may be disposed in the fluid circuit 204. The temperature sensor(s) 212 is configured to detect the temperature of the fluid circuit 204 at one or more positions within the fluid circuit 204. Various types of temperature sensors can be utilized in the environment 200. According to various implementations, the temperature sensor(s) 212 include one or more thermocouples, thermistors, Peltier elements, or any combination thereof. In various examples, the temperature sensor(s) 212 is configured to output an electrical signal indicative of one or more detected temperatures by the temperature sensor(s) 212.

In some cases, one or more pressure sensor(s) 214 are disposed in the fluid circuit 204. The pressure sensor(s) 214 is configured to detect a pressure at one or more positions within the fluid circuit 204. In some cases, the pressure sensor(s) 214 include one or more capacitive and/or piezoelectric pressure sensors. For example, the pressure sensor(s) 214 include a membrane disposed between a space with a reference pressure and a space within the fluid circuit 204. When the pressure in the space within the fluid circuit 204 is different than the reference pressure, the membrane is configured to deform. In various implementations, the pressure sensor(s) 214 detects the pressure in the space based on an amount of deformation of the membrane. For instance, the capacitance of a capacitor including the membrane as a plate, or an electrical signal output by the membrane (e.g., due to the piezoelectric effect), is indicative of the deformation of the membrane and the pressure in the space.

According to some examples, one or more light sensors 216 are disposed in the fluid circuit 204. In some cases, the light sensor(s) 216 include one or more light sources (e.g., light-emitting diodes (LEDs)) and one or more light detectors (e.g., photodiodes, phototransistors, etc.) configured to detect light emitted by the light source(s). In some cases, the fluid in the fluid circuit 204 is physically disposed between the light source(s) and the light detector(s). An amount of light detected by the light detector(s), for example, is dependent on an amount of the light that is transmitted (e.g., not absorbed) by the fluid in the fluid circuit 204. In some examples, the light detector(s) is configured to detect an amount of light that is both emitted by the light source(s) and reflected by the fluid in the fluid circuit 204. In some cases, a frequency of the light emitted by the light source(s) and detected by the light detector(s) is optimized for absorbance and/or reflectance of a particular material (e.g., oxidized metal particles) in the fluid disposed in the fluid circuit 204. For example, the absorbance of the light of an aqueous solution of the oxidized nanoparticles at a predetermined concentration may be greater than a predetermined threshold. In various cases, the light detector(s) output an electrical signal indicative of an amount of light absorbed and/or reflected by the fluid in the fluid circuit 204. This signal may be indicative of an amount of the material present in the fluid in the fluid circuit 204.

The desalination controller 206, in various cases, receives signals from the salinity sensor(s) 208, the pH sensor(s) 210, the temperature sensor(s) 212, the pressure sensor(s) 214, the light sensor(s) 216, or any combination thereof, that are indicative of parameters detected by the respective sensors. In some cases, the signals include one or more analog signals, and the desalination controller 206 includes one or more analog-to-digital converters (ADCs) configured to convert the signals into digital signals indicative of the detected parameters. In some cases, the signals output by the sensors include digital signals that are indicative of the detected parameters. In various cases, the desalination controller 206 is configured to analyze data (e.g., in the form of digital signals) indicative of the detected parameters.

In various implementations, the desalination controller 206 is communicatively coupled to one or more active elements that are configured to change conditions within the fluid circuit 204. The desalination controller 206, for instance, is configured to output one or more signals (also referred to as “control signals”) to the active elements in order to cause changes to conditions within the fluid circuit 204.

In various cases, one or more pumps 218 are present in the fluid circuit 204. The pump(s) 218, in various cases, are configured to control pressure differentials between different subspaces in the fluid circuit 204, thereby inducing fluid flow within the fluid circuit 204. The pump(s) 218, for instance, include at least one peristaltic pump, at least one centrifugal pump, at least one diaphragm pump, at least one magnetic pump, or any combination thereof. In some cases, the pump(s) 218 can include one or more propellers configured to cause fluid movement within the fluid circuit 204.

According to some implementations, one or more valves 220 are present in the fluid circuit 204. The valve(s) 220, for instance, are configured to selectively open or close portions of the fluid circuit 204 to fluid flow. In various cases, the valve(s) 220 include check valves, ball valves, butterfly valves, or any combination thereof. Notably, the valve(s) 220 may include at least one valve configured to control liquid (e.g., saline) flow in the fluid circuit 204 and/or to control gas (e.g., air) flow in the fluid circuit 204.

In various cases, one or more heaters 222 are present in the fluid circuit. The heater(s) 222, for instance, are configured to heat portions of the fluid circuit 204. In some cases, the heater(s) 222 include one or more resistive elements that output heat when a voltage is applied. In some cases, the heater(s) 222 include one or more Peltier elements.

In implementations, a desalination substrate 224 can be disposed within the fluid circuit 204. The desalination substrate 224, for instance, can include a porous substrate impregnated with metal particles. In implementations, the desalination controller 206 can monitor a condition of the desalination substrate 224. For example, the desalination controller 206, receives signals from the salinity sensor(s) 208, the pH sensor(s) 210, the temperature sensor(s) 212, the pressure sensor(s) 214, the light sensor(s) 216, or any combination thereof, that are indicative of a condition of the desalination substrate 224. A condition of the desalination substrate 224 can include a measurement of desalination efficiency. Based on a condition of the desalination substrate 224, the desalination controller 206 can determine if regeneration and/or replacement of the desalination substrate 224 is indicated.

In some examples, the pump(s) 218 and/or valve(s) 220 are configured to control the flow of fluid between the fluid circuit 204 and one or more external spaces (e.g., receptacles). These external spaces may include a gas source 226 (e.g., the gas source 128), a saline water source 228 (e.g., the saline water source 102), a buffer source 230, and one or more waste receptacles 232. In various cases, the gas source 226 is a space that contains a gas (e.g., air and/or oxygen). In some examples, the saline water source 228 includes saline water that is to be desalinated by the desalination system. In various cases, the buffer source 230 is a space that includes a buffer solution (e.g., a bicarbonate solution) that can be used to adjust the pH within the fluid circuit 204. In various examples, the waste receptacle(s) 232 includes a space that is configured to receive waste and/or captured solute(s) from the fluid in the fluid circuit 204. These external spaces, for instance, include one or more tanks, tubs, or other containers that are fluidly and selectively coupled to the fluid circuit 204.

In various implementations of the present disclosure, the desalination controller 206 is configured to control the pump(s) 218, the valve(s) 220, the heater(s) 222, or any combination thereof, based on one or more parameters detected by the salinity sensor(s) 208, the pH sensor(s) 210, the temperature sensor(s) 212, the pressure sensor(s) 214, the light sensor(s) 216, or any combination thereof. For example, the desalination controller 206 may output a control signal that activates or deactivates the pump(s) 218, the valve(s) 220, the heater(s) 222, or any combination thereof, in response to determining that one or more parameters are above a first threshold and/or below a second threshold.

In particular cases, the desalination controller 206 controls the pump(s) 218 and/or the valve(s) 220 in response to detecting that a salinity detected by the salinity sensor(s) 208 is above a threshold. In some examples, the desalination controller 206 causes the pump(s) 218 to recirculate fluid in the fluid circuit 204 until the salinity is below the threshold. In some examples, the desalination controller 206 causes the valve(s) 220 to block the fluid from being discharged (e.g., into a filter, such as the filter 138, or into a settling tank, such as the settling tank 134) until the salinity is above the threshold. In some examples, the desalination controller 206 causes the pump(s) 218 and/or valve(s) 220 to release saline water from the saline water source 228 into the fluid circuit 204 in response to detecting that the salinity is below the threshold.

According to some cases, the desalination controller 206 controls conditions within the fluid circuit 204 based on a pH detected by the pH sensor(s) 210. In some examples, the desalination substrate has a relatively low pH (e.g., due to the presence of phenols added to the desalination substrate during metal particle synthesis). It has been observed that the efficiency and speed by which the desalination substrate removes solute(s) from saline can be enhanced by lowering the pH of the saline added to the fluid circuit 204. In some examples, the desalination controller 206 causes the pump(s) 218 and/or valve(s) 220 to release buffer (e.g., water containing bicarbonate or some other type of basic solution) from the buffer source 230 into the fluid circuit 204 in response to detecting that the pH detected by the pH sensor(s) 210 is below a threshold.

In some examples, the desalination controller 206 adjusts conditions within the fluid circuit 204 based on a temperature detected by the temperature sensor(s) 212. In various implementations, it has been observed that the efficiency and speed by which the desalination substrate removes solute(s) from saline can be enhanced by controlling the temperature of the fluid in the fluid circuit 204 to be in a range of 25° C. to 50° C. In various cases, the desalination controller 206 causes the heater(s) 222 to activate in response to determining that a temperature detected by the temperature sensor(s) 212 is below a threshold.

In various instances, the desalination controller 206 adjusts the conditions within the fluid circuit 204 based on a pressure detected by the pressure sensor(s) 214. A pressure differential between different locations along the fluid circuit 204 may be indicative of an amount of fluid flow in the fluid circuit 204. In some cases, an initial phase of flow through the fluid circuit 204 is achieved via hydrostatic flow from the saline water source 228 into the fluid circuit 204, wherein the saline water source 228 may be elevated with respect to the fluid circuit 204. However, after a sufficient amount of saline water has left the saline water source 228, in some cases, pressure in the fluid circuit 204 may equilibrate, causing limited to nonexistent fluid flow. In some examples, the desalination controller 206 activates the pump(s) 218 to activate in response to determining that a difference between a pressure detected at a first part of the fluid circuit 204 and a pressure detected at a second part of the fluid circuit 204 is below a threshold.

According to some cases, the desalination controller 206 may cause the valve(s) 220 to selectively vent gasses in the fluid circuit 204 to an environment outside of the fluid circuit 204. For instance, if the fluid circuit 204 is sealed from an external environment, and the gas source 226 releases gas into the fluid circuit 204, the pressure within the fluid circuit 204 may build to an undesirable level. In various cases, the desalination controller 206 causes the valve(s) 220 to vent fluid in the fluid circuit 204 to the external environment in response to detecting that a pressure detected by the pressure sensor(s) 214 is above a threshold.

In some examples, the desalination controller 206 selectively causes removal of waste and/or solute from fluid in the fluid circuit 204. In particular examples, metal particles capture solute from the fluid during oxidation. The oxidation of metal particles in the fluid, in various cases, changes the absorbance and/or reflectance of the fluid. For instance, oxidized nanoparticles can cause treated water to appear opaque and/or as an orange color. In various cases, the desalination controller 206 causes the pump(s) 218 and/or valve(s) 220 to release waste and solute from the fluid circuit 204 and into the waste receptacle(s) 232 in response to determining that a light absorbance and/or reflectance of the fluid in the fluid circuit 204 exceeds a first threshold and/or that a light transmittance of the fluid in the fluid circuit 204 is below a second threshold. The desalination controller 206, in various implementations, determines the light absorbance, reflectance, or transmittance based on signals output by the light sensor(s) 216.

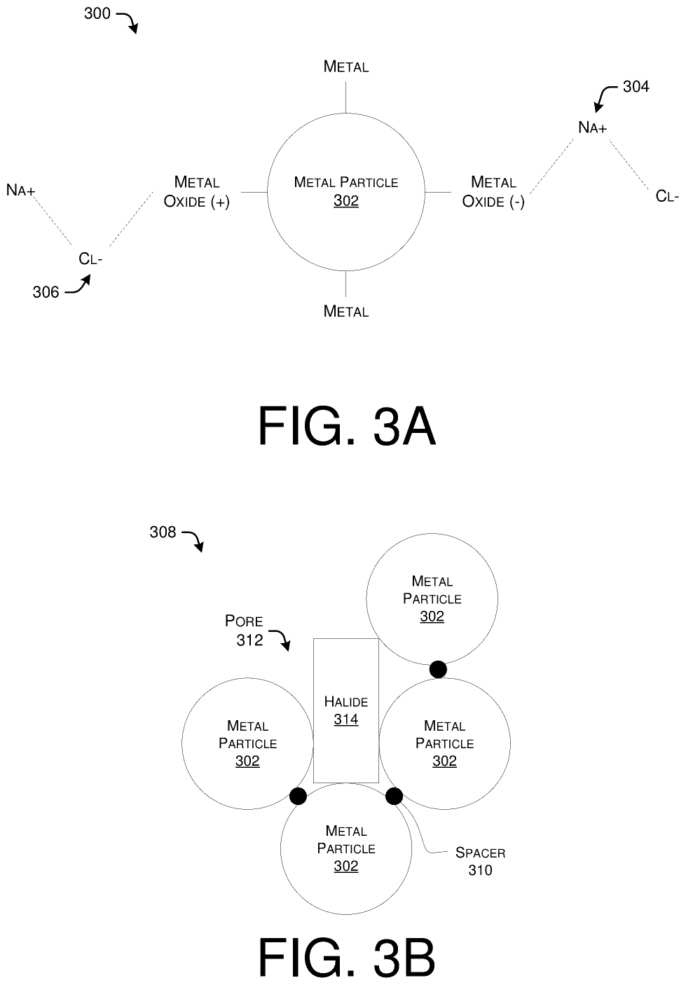

FIGS. 3A and 3B illustrate examples of metal particles configured to adsorb sodium (Na) and chlorine (Cl) atoms. FIG. 3A illustrates an example environment 300 in which a metal particle 302 captures a sodium ion (Na+) 304 and a chlorine ion (Cl−) 306. Although FIGS. 3A and 3B are described with reference to removing sodium and chlorine ions, it should be understood that in some cases, other positive and negative ions can be removed from water using similar techniques.

The metal particle 302 may include at least one of copper, aluminum, magnesium, manganese, zinc, or iron (e.g., ZVI or Fe(0)). According to various implementations, the metal particle 302 may have a mean particle size that is less than 1000 nm. For instance, the mean particle size can be calculated by observing a sample of metal particles under a microscope, measuring lengths of the metal particles in at least one direction, and then calculating an arithmetic mean of the lengths. For instance, an AMSCOPE 3.5x-180x Light Emitting Diode (LED) Zoom Digital Stereo Microscope with a 10 MP camera could be used to capture an image of the particles (e.g., in or out of solution). Image processing software can be used to perform point counting (e.g., software provided by National scientific and Technical Research Council, Buenos Aries, Argentina). The point counting software may also be used to identify the diameters of the particles.

In some cases, a length (e.g., a diameter) of the metal particle 302 may be between 10 and 100 nm, 20 to 80 nm, or 35 to 55 nm. In various implementations, the metal particle 302 may have a surface area between about 0.1 square meters per gram (m2/g) to about 25 m2/g. As used herein, the term “about” can refer to a range of numbers that would be rounded to the number specified. For instance, the term “about 0.1” may refer to a range of 0.05 to 0.14.

In some cases, when the metal particle 302 begins to corrode (i.e., oxidize), metal on the surfaces of the particles is hydrolyzed, and hydroxyl (—OH) groups are formed on the surfaces of the particles. The hydroxyl groups on the surfaces are amphoteric, and can have a negative charge or a positive charge depending on a pH of the solution.

According to some implementations, at least some of the metal on the surface of the metal particle 302 can be oxidized while immersed in water. When ZVI, for instance becomes oxidized, two types of complexes may be formed: FeOOH2+ and FeOOH−. The positively charged FeOOH2+ may electrostatically attract the negatively charged Cl− 306 dissolved in the water. The negatively charged FeOOH− may electrostatically attract the positively charged Na+ 304 dissolved in the water. The electrostatic attraction between the charged complexes and the Cl− 306 and Na+ 304 ions may cause a first layer of Cl− 306 and Na+ 304 ions to be adsorbed onto the surface of the metal particle 302.

Once a first layer of Na+ 304 and Cl− 306 is adsorbed onto the surface of the metal particle 302, additional ions may be further adsorbed onto the first layer. For instance, additional negatively charged Cl− ions 306 may be electrostatically attracted to the positively charged Na+ 304 in the first layer, and additional positively charged Na+ 304 may be electrostatically attracted to the negatively charged Cl− 306 in the first layer. Multiple layers of Cl− 306 and Na+ 304 may assemble on the surface of the metal particle 302. In some cases, the Cl− 306 and Na+ 304 may form a crystal structure.

The adsorption of the Na+ 304 and Cl− 306 due to electrostatic forces with oxidized forms of the metal in the metal particle 302 may occur relatively quickly. As Cl− 306 is attracted to, and attaches to, Fe(OH)4+ (for example), functional groups on the surface of the metal particle 302, a subsequent, slower reaction may take place that also causes desalination. In some examples, the Cl− 306 may further catalyze the oxidation of Fe(0) in the metal particle 302. Additional Cl− 306 may diffuse through the surface layer of the metal particle 302 and cause further oxidation of the Fe(0) below the outer surface of the metal particle 302 and within the interior of the metal particle 302. Additional layers of Fe-O-Cl and Fe-O-Na may be generated within the interior of the metal particle 302.

Both reactions (the surface adsorption and capture by metal within the interior of the metal particle 302) may cause water uptake. In addition, when the metal particle 302 is submerged in water, the salinity gradient may increase as a distance to the metal particle 302 decreases, due to the capture of the Na+ 304 and the Cl− 306. Accordingly, a desalination substrate including metal particles 302 may expand in size, due to water uptake and osmosis, when exposed to saline.

FIG. 3B illustrates an example environment 308 of multiple metal particles 302 capturing Na and Cl dissolved in water. The multiple metal particles 302 may be packed together. In some cases, spacers 310 may be disposed between the metal particles 302. Some examples of spacers 310 include a starch (e.g., potato starch), carboxy methyl cellulose, polyvinyl pyrrolidine, or the like. The spacers 310 may prevent the metal particles 302 from agglomerating. Although not illustrated, in some cases, at least some of the metal particles 302 may be directly touching each other.

In various implementations, a pore 312 can be present between the metal particles 302. In some cases, multiple pores 312 can be present between groups of the metal particles 302. The pore 312 may be generated based on the geometries of the metal particles 302 and the spacers 310. In various examples, the pore 312 may have a width of 20-100 nm.

When the metal particles 302 are exposed to water in which chlorine and sodium atoms are dissolved, the sodium and chlorine atoms may be adsorbed onto the surfaces of the metal particles 302. In some cases, the sodium and chlorine atoms may assemble into a halide 314 disposed within the pore 312. The halide 314 may be a crystal including the sodium and chlorine atoms.

In various implementations, the metal particles 302 can remove a significant amount of salt from water. For example, in the case of Na and Cl removal from water, a ratio of a weight or mass of Na and Cl removed from saline water by the metal particles 302 to a weight or mass of a metal in the metal particles 302 (i.e., NaCl:Fe) can be as much as 20:1.

In some cases, additional contaminants can be removed from the water by the metal particles 302. For example, various other solutes described herein can also be captured by the metal particles 302.

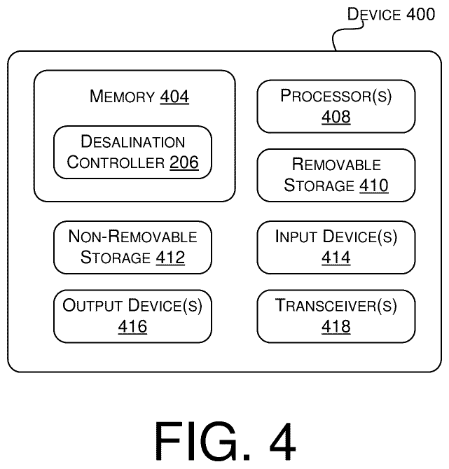

FIG. 4 illustrates at least one example device 400 configured to enable and/or perform various functionality discussed herein. Further, the device(s) 400 can be implemented as one or more server computers, a network element on a dedicated hardware, as a software instance running on a dedicated hardware, or as a virtualized function instantiated on an appropriate platform, such as a cloud infrastructure, and the like. It is to be understood in the context of this disclosure that the device(s) 400 can be implemented as a single device or as a plurality of devices with components and data distributed among them.

As illustrated, the device(s) 400 comprise a memory 404. In various implementations, the memory 404 is volatile (including a component such as Random Access Memory (RAM)), non-volatile (including a component such as Read Only Memory (ROM), flash memory, etc.) or some combination of the two.

The memory 404 may include various components, such as instructions for executing various functions of the desalination controller 206. The memory 404 can store methods, threads, processes, applications, or any other sort of executable instructions. The memory 404 can also store files and/or databases.

The memory 404 may include various instructions (e.g., instructions of the desalination controller 206), which can be executed by at least one processor 408 to perform operations. In some cases, the processor(s) 408 includes a Central Processing Unit (CPU), a Graphics Processing Unit (GPU), or both CPU and GPU, or other processing unit or component known in the art.

The device(s) 400 can also include additional data storage devices (removable and/or non-removable) such as, for example, magnetic disks, optical disks, or tape. Such additional storage is illustrated in FIG. 4 by removable storage 410 and non-removable storage 412. Tangible computer-readable media can include volatile and nonvolatile, removable and non-removable media implemented in any method or technology for storage of information, such as computer readable instructions, data structures, program modules, or other data. The memory 404, removable storage 410, and non-removable storage 412 are all examples of computer-readable storage media. Computer-readable storage media include, but are not limited to, RAM, ROM, EEPROM, flash memory or other memory technology, CD-ROM, Digital Versatile Discs (DVDs), Content-Addressable Memory (CAM), or other optical storage, magnetic cassettes, magnetic tape, magnetic disk storage or other magnetic storage devices, or any other medium which can be used to store the desired information and which can be accessed by the device(s) 400. Any such tangible computer-readable media can be part of the device(s) 400.

The device(s) 400 also can include input device(s) 414, such as a keypad, a cursor control, a touch-sensitive display, voice input device, one or more sensors, and the like. In various cases, the device(s) 400 include output device(s) 416 such as a display, speakers, printers, one or more active elements (e.g., pumps, valves, heaters, etc.), and the like. In particular implementations, a user can provide input to the device(s) 400 via a user interface associated with the input device(s) 414 and/or the output device(s) 416.

As illustrated in FIG. 4, the device(s) 400 can also include one or more wired or wireless transceiver(s) 418. For example, the transceiver(s) 418 can include a Network Interface Card (NIC), a network adapter, a LAN adapter, or a physical, virtual, or logical address to connect to the various base stations or networks contemplated herein, for example, or the various user devices and servers. To increase throughput when exchanging wireless data, the transceiver(s) 418 can utilize Multiple-Input/Multiple-Output (MIMO) technology. The transceiver(s) 418 can include any sort of wireless transceivers capable of engaging in wireless, Radio Frequency (RF) communication. The transceiver(s) 418 can also include other wireless modems, such as a modem for engaging in Wi-Fi, WiMAX, Bluetooth, or infrared communication. In some implementations, the transceiver(s) 418 can be used to communicate between various functions, components, modules, or the like, that are comprised in the device(s) 400.

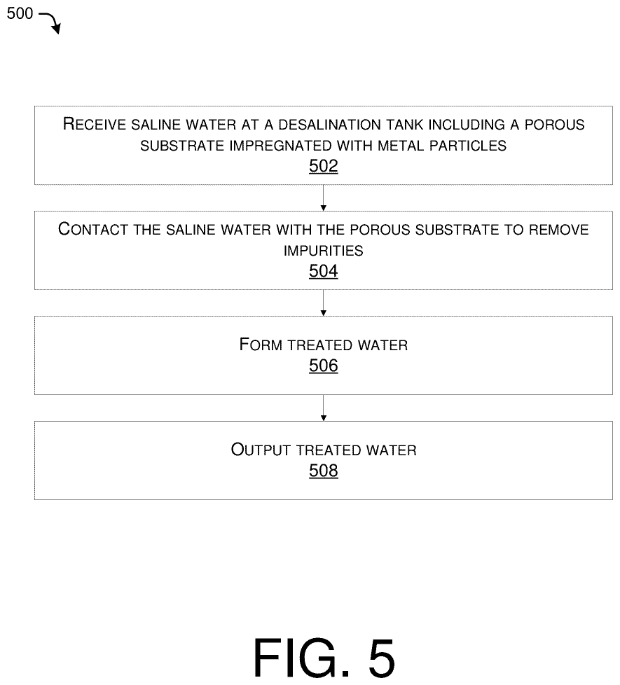

FIG. 5 illustrates an example process 500 for capturing solutes from an aqueous solution. The process 500 may be performed by an entity, such as a desalination system, at least one processor, a computing device, one or more desalination tanks (also referred to as “desalination reactors”), or any combination thereof.

At 502, the process 500 includes receiving saline water at a desalination tank, the desalination tank comprising a porous substrate impregnated with metal particles in a fixed position within the desalination tank. In implementations, the saline water received at 502 can include seawater, industrial waste, mining waste, agricultural waste, produced water (e.g., a byproduct of ground oil and/or gas extraction), flowback (e.g., water injected and returned during a hydraulic fracturing process), or any combination thereof. In some examples, the saline water includes brine. In implementations, the saline water is received from one or more upstream water purification stages, such as from a conventional water treatment system, wherein the one or more water purification stages can include further desalination, oxidation, filtration, activated carbon, ultraviolet light, coagulation, or flocculation. For example, filtration can include a membrane filter, a particulate filter, a ceramic filter, a glass fiber filter, a hollow fiber filter, or any combination thereof. For example, the process 500 can be a mobile process capable of receiving saline water from one or more sources at a first time and receiving saline water from one or more different sources at a second time. For example, the saline water can include an effluent of a water purification stage, such as an existing water treatment system.

In implementations, the porous substrate includes at least one of anthrosite, a zeolite, activated carbon, a carbon matrix, alumina, an inorganic oxide, silica, or sand. In implementations, the porous substrate includes pores and/or channels, and wherein pores and/or channels in the porous substrate have widths in a range of about 10 nm to about 20 mm. In implementations, the porous substrate includes at least one of a fused metal powder, a metallic foam, a scaffold, a truss, one or more rods, a continuous or semi-continuous surface coating disposed on a substrate, one or more patterns imprinted on a substrate, one or more pellets, or a slurry including particles fixed within the desalination tank by at least one of a membrane, a screen, or a mesh. In implementations, a fused metal powder can include zinc oxide particles (powder) fused with the metal particles. In implementations, the metallic foam can include the metal particles. In implementations, the metal particles include at least one of macroparticles, microparticles, or nanoparticles. In some cases, the metal particles include a transition metal. For example the transition metal includes at least one of copper, aluminum, magnesium, manganese, zinc, or iron. In implementations, a metal in the metal particles include a (0) valency state, a (I) valency state, (II) valency state, or a (III) valency state, for example the metal particles include zero valent iron (ZVI).

In implementations, wherein the metal particles being first metal particles, the process 500 further includes a non-porous substrate imprinted with one or more patterns and/or channels, or a continuous or semi-continuous surface coating including the porous substrate disposed on the non-porous substrate, wherein the non-porous substrate is impregnated with second metal particles.

At 504, the process 500 includes contacting the saline water with the porous substrate to remove impurities from the water, thereby forming treated water at 506. In some cases, the impurities include at least one of a salt, a solid material, or a metal. In implementations, at least a portion of the impurities are dissolved in the saline water.

At 508, the process 500 includes outputting the treated water. In implementations, the process 500 further includes passing the treated water through one or more water purification stages. For example, the one or more water purification stages can include further desalination, oxidation, filtration, activated carbon, ultraviolet light, coagulation, or flocculation. For example, filtration can include a membrane filter, a particulate filter, a ceramic filter, a glass fiber filter, a hollow fiber filter, or any combination thereof.

In implementations, the process 500 further includes injecting an oxidizing agent into the saline water. For example, injecting the oxidizing agent into the saline water can includes bubbling a gas through the saline water. In implementations, the oxidizing agent can include at least one of oxygen, ozone, a peroxide, a hypochlorite, a perchlorate, a permanganate, nitric acid, or potassium dichromate. For example, the oxygen can include oxygen from air, the peroxide can include hydrogen peroxide, the hypochlorite can include sodium hypochlorite, the perchlorate can include sodium perchlorate, and the permanganate can include potassium permanganate.

The process 500 can further include regenerating the metal particles. In implementations, regenerating the metal particles can include backwashing the porous substrate and/or redissolving the metal particles. In implementations, redissolving the metal particles includes adding a reducing agent and/or flushing the porous substrate with clean water. In implementations, the reducing agent can include nitrogen gas, an oxygen-consuming microorganism, a nitride, a nitrate, calcium, barium, sodium borohydride, an alcohol, a phenol, uric acid, urea, tartaric acid, maleic acid, or tannic acid.

In implementations, the process 500 can further include adding an additive to the treated water, the additive including at least one of electrolytes, chlorine, or fluorine. In some cases, the type and quantity of additive added to the treated water can depend on the intended use of the treated water. In some cases, the treated water can be potable water, agricultural water, process water. For example, the treated water can be delivered to a user, to an agricultural application, to a municipality, or to the environment.

### EXAMPLE CLAUSES

The following Clauses provide various examples of the present disclosure. However, implementations of the present disclosure are not limited to the Clauses listed herein.

1. A desalination apparatus including a porous substrate impregnated with metal particles.

2. The desalination apparatus of clause 1, wherein the metal particles are immobilized within and/or on a surface of the porous substrate.

3. The desalination apparatus of any of clauses 1-2, wherein the metal particles are disposed on one or more surfaces of the porous substrate.

4. The desalination apparatus of any of clauses 1-3, wherein the metal particles are coated onto one or more surfaces of the porous substrate.

5. The desalination apparatus of any of clauses 1-4, wherein the porous substrate includes at least one of a hydrogel, anthrosite, a zeolite, activated carbon, a carbon matrix, alumina, an inorganic oxide, silica, or sand.

6. The desalination apparatus of any of clauses 1-5, wherein the porous substrate includes pores and/or channels, and wherein the pores and/or channels in the porous substrate have widths in a range of about 10 nanometers (nm) to about 20 millimeters (mm).

7. The desalination apparatus of any of clauses 1-6, wherein the porous substrate includes at least one of: a fused metal powder; a metallic foam; a scaffold; a truss; one or more rods; a continuous or semi-continuous surface coating disposed on a substrate; one or more patterns imprinted on a substrate; one or more pellets; or a slurry including particles fixed within the desalination apparatus by a membrane, a screen, or a mesh.

8. The desalination apparatus of any of clauses 1-7, wherein the metal particles include at least one of macroparticles, microparticles, or nanoparticles.

9. The desalination apparatus of any of clauses 1-8, wherein the metal particles include a transition metal.

10. The desalination apparatus of any of clauses 1-9, wherein the metal particles include at least one of copper, aluminum, magnesium, manganese, zinc, or iron.

11. The desalination apparatus of any of clauses 1-10, wherein a metal in the metal particles has at least one of a (0) valency state, a (I) valency state, (II) valency state, or a (III) valency state.

12. The desalination apparatus of any of clauses 1-11, wherein the metal particles include zero valent iron (ZVI).

13. The desalination apparatus of any of clauses 1-12, further including: a desalination tank, the porous substrate being disposed within the desalination tank.

14. The desalination apparatus of clause 13, wherein the porous substrate is removably coupled to the desalination tank.

15. The desalination apparatus of any of clauses 1-14, further including: a housing, the porous substrate being disposed within the housing, and wherein the housing is removably coupled to a spigot, a bottle, a pump, or a vacuum.

16. The desalination apparatus of any of clauses 1-15, the metal particles being first metal particles, the desalination apparatus further including: a non-porous substrate imprinted with one or more patterns and/or channels, or a continuous or semi-continuous surface coating including the porous substrate disposed on the non-porous substrate, wherein the non-porous substrate is impregnated with second metal particles.

17. A fixed bed desalination system including: a porous substrate impregnated with metal particles, and a desalination tank, wherein the porous substrate is in a fixed position within the desalination tank.

18. The fixed bed desalination system of clause 17, wherein the porous substrate includes one or more of: a fused metal powder; a metallic foam; scaffolding; one or more trusses; one or more rods; a continuous or semi-continuous surface coating disposed on a substrate; one or more patterns imprinted on a substrate; one or more pellets; or a slurry including particles fixed within the desalination tank by at least one of a membrane, a screen, or a mesh.

19. The fixed bed desalination system of any of clauses 17-18, wherein the porous substrate includes pores and/or channels, and wherein pores and/or channels in the porous substrate have widths in a range of about 10 nm to about 20 mm.

20. The fixed bed desalination system of any of clauses 17-19, wherein the porous substrate includes at least one of a hydrogel, anthrosite, a zeolite, activated carbon, a carbon matrix, alumina, an inorganic oxide, silica, or sand.

21. The fixed bed desalination system of any of clauses 17-20, wherein the metal particles include at least one of macroparticles, microparticles, or nanoparticles.

22. The fixed bed desalination system of any of clauses 17-21, the metal particles being first metal particles, the fixed bed desalination system further including: a non-porous substrate imprinted with one or more patterns and/or channels, or a continuous or semi-continuous surface coating including the porous substrate disposed on the non-porous substrate, wherein the non-porous substrate is impregnated with second metal particles.

23. The fixed bed desalination system of any of clauses 17-22, wherein the metal particles include a transition metal.

24. The fixed bed desalination system of clause 23, wherein the transition metal includes at least one of copper, aluminum, magnesium, manganese, zinc, or iron.

25. The fixed bed desalination system of any of clauses 17-24, wherein a metal in the metal particles has a (0) valency state, a (I) valency state, (II) valency state, or a (III) valency state.

26. The fixed bed desalination system of any of clauses 17-25, wherein the metal particles include zero valent iron (ZVI).

27. The fixed bed desalination system of any of clauses 17-26, wherein the porous substrate is removably coupled to the desalination tank.

28. The fixed bed desalination system of any of clauses 17-27, wherein the porous substrate is suspended within the desalination tank.

29. The fixed bed desalination system of any of clauses 17-28, wherein the porous substrate includes beds disposed in series within the desalination tank.

30. The fixed bed desalination system of any of clauses 17-29, wherein the porous substrate includes one or more rods, columns, or beds disposed within the desalination tank.

31. The fixed bed desalination system of any of clauses 17-30, wherein the desalination tank is portable.

32. A method of desalinating water, the method including: receiving saline water at a desalination tank, the desalination tank including a porous substrate impregnated with metal particles in a fixed position within the desalination tank, contacting the saline water with the porous substrate to remove impurities from the water, thereby forming treated water, and outputting the treated water.

33. The method of clause 32, wherein the porous substrate includes at least one of anthrosite, a zeolite, activated carbon, a carbon matrix, alumina, an inorganic oxide, silica, or sand.

34. The method of any of clauses 32-33, wherein the porous substrate includes pores and/or channels, and wherein pores and/or channels in the porous substrate have widths in a range of about 10 nm to about 20 mm.

35. The method of any of clauses 32-34, wherein the porous substrate includes at least one of: a fused metal powder; a metallic foam; a scaffold; a truss; one or more rods; a continuous or semi-continuous surface coating disposed on a substrate; one or more patterns imprinted on a substrate; one or more pellets; or a slurry including particles fixed within the desalination tank by at least one of a membrane, a screen, or a mesh.

36. The method of any of clauses 32-35, wherein the metal particles include at least one of macroparticles, microparticles, or nanoparticles.

37. The method of any of clauses 32-36, wherein the metal particles include a transition metal.

38. The method of clause 37, wherein the transition metal includes at least one of copper, aluminum, magnesium, manganese, zinc, or iron.

39. The method of any of clauses 32-38, wherein a metal in the metal particles has a (0) valency state, a (I) valency state, (II) valency state, or a (III) valency state.

40. The method of any of clauses 32-39, wherein the metal particles include zero valent iron (ZVI).

41. The method of any of clauses 32-40, the metal particles being first metal particles, the method further including: imprinting a non-porous substrate with one or more patterns and/or channels, and/or disposing a continuous or semi-continuous surface coating including the porous substrate onto the non-porous substrate, wherein the one or more patterns and/or channels, and/or the continuous or semi-continuous surface coating, are impregnated with second metal particles.

42. The method of any of clauses 32-41, wherein impurities include at least one of a salt, a solid material, or a metal.

43. The method of any of clauses 32-42, wherein at least a portion of the impurities are dissolved in the saline water.

44. The method of any of clauses 32-43, further including: injecting an oxidizing agent into the saline water.

45. The method of clause 44, wherein injecting the oxidizing agent into the saline water includes bubbling a gas through the saline water.

46. The method of any of clauses 32-45, further including passing the treated water through one or more water purification stages.

47. The method of clause 46, wherein the one or more water purification stages include further desalination, oxidation, filtration, activated carbon, ultraviolet light, coagulation, or flocculation.

48. The method of clause 47, wherein filtration includes a membrane filter, a particulate filter, a ceramic filter, a glass fiber filter, a hollow fiber filter, or any combination thereof.

49. The method of any of clauses 32-48, further including adding an additive to the treated water, the additive including at least one of electrolytes, chlorine, or fluorine.

50. The method of any of clauses 32-49, further including regenerating the metal particles.

51. The method of clause 50, wherein regenerating the metal particles includes backwashing the porous substrate and/or redissolving the metal particles.

52. The method of any of clauses 32-51, further including delivering the treated water to a user, to an agricultural application, to a municipality, or to the environment.

### Conclusion

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

1-52. (canceled)

53. A desalination system comprising:
a desalination tank;
a porous substrate disposed in a fixed position within the desalination tank and impregnated with metal particles, the metal particles being configured to remove salt from saline water by oxidizing when contacted by the saline water.

54. The desalination system of claim 53, wherein the porous substrate is removably coupled to the desalination tank.

55. The desalination system of claim 53 wherein the metal particles comprise at least one metal in a (0) valency state, the at least one metal comprising at least one of copper, aluminum, magnesium, manganese, zinc, or iron.

56. The desalination system of claim 53, the porous substrate being a first porous substrate, the desalination system comprising:
a fluid circuit comprising the desalination tank, and
a second porous substrate disposed within the fluid circuit, the second porous substrate being arranged in series and/or in parallel with the first porous substrate within the fluid circuit.

57. The desalination system of claim 53, wherein the desalination tank is portable and configured to be removably coupled to a spigot, a bottle, a pump, or a vacuum.

58. An apparatus comprising metal particles impregnated into a porous substrate, the metal particles being configured to remove salt from saline water by oxidizing when contacted by the saline water.

59. The apparatus of claim 58, wherein the metal particles are immobilized within and/or on a surface of the porous substrate.

60. The apparatus of claim 58, wherein the porous substrate comprises at least one of a hydrogel, anthrosite, a zeolite, activated carbon, a carbon matrix, alumina, an inorganic oxide, silica, or sand.

61. The apparatus of claim 58, wherein pores and/or channels are disposed in the porous substrate, and
wherein the pores and/or channels have widths in a range of about 10 nanometers (nm) to about 20 millimeters (mm).

62. The apparatus of claim 58, wherein the porous substrate comprises at least one of:
a fused metal powder;
a metallic foam;
a scaffold;
a truss;
a rod;
a column;
a bed;
a continuous or semi-continuous surface coating disposed on a base substrate;
one or more patterns imprinted on the base substrate;
one or more pellets; or
a slurry comprising particles fixed by a membrane, a screen, or a mesh.

63. The apparatus of claim 58, wherein the metal particles comprise at least one of macroparticles, microparticles, or nanoparticles.

64. The apparatus of claim 58, wherein the metal particles comprise at least one transition metal.

65. The apparatus of claim 58, wherein the metal particles comprise at least one of copper, aluminum, magnesium, manganese, zinc, or iron.

66. The apparatus of claim 58, wherein at least one metal in the metal particles has at least one of a (0) valency state, a (I) valency state, (II) valency state, or a (III) valency state.

67. The apparatus of claim 58, wherein the metal particles comprise zero valent iron (ZVI).

68. A method, comprising:
receiving saline water at a desalination tank, the desalination tank comprising a porous substrate impregnated with metal particles and disposed in a fixed position within the desalination tank;
generating treated water by contacting the saline water with a porous substrate disposed in a fixed position within the desalination tank, the porous substrate being impregnated with metal particles configured to remove salt from the saline water; and
outputting the treated water.

69. The method of claim 68, wherein the metal particles are further configured to remove an impurity from the saline water, the impurity comprising a solid material and/or a metal dissolved in the saline

70. The method of claim 68, wherein the metal particles comprise at least one of copper, aluminum, magnesium, manganese, zinc, or iron.

71. The method of claim 68, further comprising:
introducing an oxidizing agent into the saline water.

72. The method of claim 71, further comprising:
wherein introducing the oxidizing agent into the saline water comprises bubbling a gas through the saline water.
